(19) United States
(12) Patent Application Publication
(10) Pub. No.: US 2012/0191746 A1
(43) Pub. Date: Jul. 26, 2012

(54) DICTIONARY SYSTEM

(76) Inventors: Tomoko Tashiro, Saitama (JP); Nozomi Nakahashi, Hokkaido (JP); Yoshitaka Ishii, Tokyo (JP)

(21) Appl. No.: 12/810,684

(22) PCT Filed: Aug. 22, 2008
(86) PCT No.: PCT/JP2008/065013

§ 371 Date: Jun. 25, 2010

(30) Foreign Application Priority Data
Dec. 26, 2007 (JP) 2007-334013

(51) Int. Cl. G06F 17/30

(52) U.S. Cl. 707/769; 707/E17.014

(57) ABSTRACT

A dictionary system available for the use in document search or available for the use in normalization of a term constituting a document. A dictionary system capable of supporting a complex term composed of a plurality of simple terms. A dictionary system includes a storage for storing a simple term dictionary unit containing at least one simple term and a complex term dictionary unit which represents a complex term that contains one of the simple terms constituting the simple term dictionary unit. Each simple term constituting the complex term is referred to through a pointer (unit identifier) to the simple term dictionary unit.

### TECHNICAL FIELD

The present invention relates to a dictionary system. In particular, the present invention relates to a dictionary system for searching a document or for normalizing terms that constitute a document.

### BACKGROUND ART

Conventionally, various kinds of search methods have been proposed to efficiently obtain document data containing information targeted by a user, for example, in a document database, etc., (including a web site on the so-called Internet) realized by a system. For example, a technique described in Patent Document 1 extracts a word to be used as a keyword from a document to be registered, and refers to data of a plurality of words having specific meaning for the word, such as different notation, different character style, equivalent term, and synonym, etc., to obtain a standard notation. Then, it creates data for search that associates a word to be used as a keyword, data of words containing a standard notation, and a document to be registered. At the time of later search, from a user's search condition, it extracts a word to be used as a keyword and refers to data of a plurality of words having specific meaning for the word, such as different notation, different character style, equivalent term, and synonym, etc., to obtain a standard notation. Then, from the data for search, it searches for a word to be used as a keyword, and document data having a word that matches with data of words containing a standard notation, and outputs the search result. Thus, a technique for searching document data containing a word having a relation with a word contained in a user's search condition, such as different notation, different character style, equivalent term, and synonym, etc., is described.

[Patent Document 1] Japanese Unexamined Patent Application, First Publication No. 2004-86307

### DISCLOSURE OF THE INVENTION

### Problems to be Solved by the Invention

However, despite the technique described in Patent Document 1, it is not realistic to register and update all the standard notations for data of a plurality of words having specific meaning for the word to be used as a keyword, such as different notation, different character style, equivalent meaning, and synonym, etc. Furthermore, a technique that supports fluctuation of notation for a complex term consisting of a plurality of words is not described.

Thus, an objective of the present invention is to provide an improved dictionary system for use in document searching, or for use in normalization of a word constituting a document. Furthermore, an objective is to provide a dictionary system that is capable of supporting a complex term consisting of a plurality of simple terms.

### Means for Solving the Problems

More specifically, the present invention provides the following:

(1) A dictionary system (dictionary system 1) for searching a document or for normalizing a term constituting a document, the system comprising
a storage for storing a simple term dictionary unit containing at least one simple term and a complex term dictionary unit that represents a complex term containing one of the simple terms constituting the simple term dictionary unit,
wherein each simple term that constitutes the complex term is referred to through a pointer (unit identifier) to the simple term dictionary unit.

In accordance with such configuration of the present invention, if a simple term that constitutes a certain simple term dictionary unit constitutes a part of a complex term, a complex term dictionary unit that represents the complex term does not store the simple term directly, but refers to the simple term through a pointer to the simple term dictionary unit that the simple term constitutes.

Therefore, the dictionary system can automatically generate synonyms of the complex term by changing a simple term that constitutes the simple term dictionary unit that is referred to through the pointer. Furthermore, automatic maintenance can also be performed on the range of the synonyms of the complex term by performing maintenance of the simple terms that constitute the simple term dictionary unit.

As a result, the dictionary system can reduce system load and human load associated with maintenance.

Thus, upon searching a document containing the complex term or the simple term, the dictionary system refers to each simple term that constitutes the complex term through the pointer (unit identifier) to the simple term dictionary unit.

Therefore, upon searching a document containing the complex term or the simple term, the dictionary system does not verify and compare the synonym of the complex term or the simple term with the search request term and synonyms of the search request term sequentially. Rather it replaces each simple term that constitutes the complex term with a code containing a pointer (unit identifier) to the simple term dictionary unit. Further, as to the search request term containing the complex term or the simple term, it replaces each simple term that constitutes the complex term with a code containing the pointer (unit identifier) to the simple term dictionary unit, to thereby verify and compare the codes that contain the pointer (unit identifier).

Thus, irrespective of the number of the synonyms contained in the simple term dictionary unit or the complex term dictionary unit, the dictionary system can effectively search without losing precision by only conforming and comparing the codes that contain the pointer (unit identifier).

Similarly, upon normalizing a term of a document containing the complex term or the simple term, the dictionary system refers to each simple term that constitutes the complex term through the pointer (unit identifier) to the simple term dictionary unit.

Therefore, upon normalizing the term of the document containing the complex term or the simple term, the dictionary system can replace each simple term that constitutes the complex term with the code containing the pointer (unit identifier) to the simple term dictionary unit.

Thus, irrespective of the number of the synonyms contained in the simple term dictionary unit or the complex term dictionary unit, the dictionary system can search efficiently without losing precision of the search by replacing each simple term that constitutes the complex term with the code containing the pointer (unit identifier) for performing normalization of the term as a pretreatment at the time of accepting the search of the document.

(2) The dictionary system according to (1) comprising: a means for accepting an input of a search request term;
a means for extracting a part that matches with the complex term from the search request term accepted;
a means for extracting a part that matches with the simple term from the rest of the search request term thus accepted; and
a means for generating a search candidate term by combining all of the simple terms that are contained in the simple term dictionary unit that contains the simple term which constitutes the mached complex term and the mached simple term.

According to such configuration of the present invention, as to the complex term and simple term that are contained in the search request term that is accepted as the input, the dictionary system refers to the stored complex term dictionary unit and simple term dictionary unit, and changes the simple term that constitutes the complex term contained in the complex term dictionary unit and the simple term contained in the simple term dictionary unit to the simple terms contained in the simple term dictionary unit, respectively, to thereby perform the search by automatically generating so-called synonyms as the search candidate terms.

(3) The dictionary system according to (1) or (2) further comprising: a means for accepting an input of data that indicates a new association of a simple term or a complex term; and
a means for integrating, if the simple term(s) or the complex term(s) to which the new association is indicated constitutes a separate dictionary unit from each other, the separate dictionary units.

According to such configuration of the present invention, the dictionary system accepts an input of data that indicates a new association of a simple term or a complex term, and if the simple term or complex term to which the new association is indicated constitutes separate dictionary units, it can integrate the separate dictionary units.

(4) The dictionary system according to any of (1) to (3) further comprising: a means for accepting an input of data that indicates a new association between complex terms; and
a means for generating, if a part of the complex term to which a new association is indicated constitutes the same dictionary unit, considering that the simple term(s) or the complex term(s) that constitutes the rest of the complex term are associated with each other, a new dictionary unit containing the simple term(s) or the complex term(s) that constitutes the rest of the complex term.

According to such configuration of the present invention, the dictionary system accepts an input of data that indicates a new association between complex terms, and if parts of complex terms that are indicated the new association constitute the same dictionary unit, considering that the simple term or the complex term that constitutes the rest are associated with each other, generates a new dictionary unit containing the simple term or the complex term that constitutes the rest.

(5) The dictionary system according to any of (1) to (4) further comprising: a means for accepting an input of data that indicates division of a dictionary unit containing a plurality of simple terms or complex terms; and
a means for dividing the dictionary unit based on the accepted data that indicates division.

According to such configuration of the present invention, the dictionary system accepts an input of data that indicates division of a dictionary unit containing a plurality of simple terms or complex terms, and can divide the dictionary unit based on the accepted data that indicates division.

(6) The dictionary system according to any of (1) to (5) further comprising a means for storing, if the simple term that constitutes the simple term dictionary unit stored in the storage contains a simple term that constitutes other simple term dictionary unit or the simple term that constitutes a complex term that contains the contained simple term, as a complex term containing the contained simple term.

According to such configuration of the present invention, if the simple term that constitutes the simple term dictionary unit stored in the storage contains the simple term that constitutes other simple term dictionary units and the simple term that constitutes the complex term that constitutes a complex term dictionary unit, even in cases where a term containing a plurality of complex terms that share the contained simple term is contained in a search request term or a searching document, the dictionary system can search the plurality of complex terms without omissions.

(7) The dictionary system according to (2) in which the system considers a search to be matched if the term contained in a dictionary unit that the complex term or the simple term contained in the search request term constitutes is contained in a searching document.

According to such configuration of the present invention, the dictionary system considers that the search is matched if the term contained in the dictionary unit that the complex term or the simple term contained in the search request term constitutes is contained in a searching document, and therefore, it is possible to perform partially matching search for each dictionary unit.

(8) A program that causes a dictionary system (dictionary system 1) to perform search of a document or normalization of a term constituting a document,
in which the dictionary system comprising a storage for storing a simple term dictionary unit containing at least one simple term and a complex term dictionary unit that represents a complex term containing one of the simple terms constituting the simple term dictionary unit, and
in which the program causes the dictionary system to perform a step of referring to each simple term that constitutes the complex term through a pointer (unit identifier) to the simple term dictionary unit.

(9) A document management apparatus including the dictionary system according to (1).

### Effects of the Invention

In the dictionary system according to the present invention, if a simple term that constitutes a certain simple term dictionary unit constitutes a part of a complex term, the complex term dictionary unit that represents the complex term does not store the simple term directly, but refer to it through a pointer to the simple term dictionary unit that the simple term constitutes. Therefore, the dictionary system can automatically generate synonyms of the complex term by changing a simple term that constitutes the simple term dictionary unit referred to through the pointer. Moreover, upon searching a document containing the complex term or the simple term, the dictionary system does not verify and compare the synonym of the complex term or the simple term with the search request term and synonyms of the search request term sequentially. Rather it replaces each simple term that constitutes the complex term with a code containing a pointer (unit identifier) to the simple term dictionary unit. Further, as to the search request term containing the complex term or the simple term, it replaces each simple term that constitutes the complex term with a code containing the pointer (unit identifier) to the simple term dictionary unit, to thereby verify and compare the codes that contain the pointer (unit identifier). Alternatively, irrespective of the number of the synonyms contained in the simple term dictionary unit or the complex term dictionary unit, the dictionary system can search efficiently without losing precision of the search by replacing each simple term that constitutes the complex term with the code containing the pointer (unit identifier) for performing normalization of the term as a pretreatment at the time of accepting the search of the document.

### BRIEF DESCRIPTION OF THE DRAWINGS

FIG. 1 is a diagram showing a total configuration of a system 1 according to an example of a preferred embodiment of the present invention;

FIG. 2 is a diagram showing an example of a hardware configuration of a server 10 and a terminal 20 according to an example of the preferred embodiment of the present invention;

FIG. 3 is a diagram showing a term configuration of a dictionary system according to an example of the preferred embodiment of the present invention;

FIG. 4 is a diagram showing a dictionary unit in the dictionary system according to an example of the preferred embodiment of the present invention;

FIG. 5 is a diagram showing a data structure of a simple term in the dictionary system according to an example of the preferred embodiment of the present invention;

FIG. 6 is a diagram showing a data structure of a complex term in the dictionary system according to an example of the preferred embodiment of the present invention;

FIG. 7 is a diagram showing a total structure of a dictionary in the dictionary system according to an example of the preferred embodiment of the present invention;

FIG. 8 is a diagram showing reference in the dictionary system according to an example of the preferred embodiment of the present invention;

FIG. 9 is a diagram showing fusion in the dictionary system according to an example of the preferred embodiment of the present invention;

FIG. 10 is a diagram showing reconfiguration in the dictionary system according to an example of the preferred embodiment of the present invention;

FIG. 11 is a diagram showing setting of the dictionary to be used for instantiation in the dictionary system according to an example of the preferred embodiment of the present invention;

FIG. 12 is a diagram showing deconstruction of a request term by way of registered terms in the dictionary system according to an example of the preferred embodiment of the present invention;

FIG. 13 is a diagram showing enumeration of conversion candidate fragments by way of related terms in the dictionary system according to an example of the preferred embodiment of the present invention;

FIG. 14 is a diagram showing generation of a candidate list in the dictionary system according to an example of the preferred embodiment of the present invention;

FIG. 15 is a diagram showing setting of the dictionary to be used for instantiation in the dictionary system according to an example of the preferred embodiment of the present invention;

FIG. 16 is a diagram showing deconstruction of a request term by way of registered terms in the dictionary system according to an example of the preferred embodiment of the present invention;

FIG. 17 is a diagram showing confirmation of an existing association in the dictionary system according to an example of the preferred embodiment of the present invention;

FIG. 18 is a diagram showing analogical inference of a new association in the dictionary system according to an example of the preferred embodiment of the present invention;

FIG. 19 is a diagram showing registration of new dictionary units in the dictionary system according to an example of the preferred embodiment of the present invention;

FIG. 20 is a diagram showing division in the dictionary system according to an example of the preferred embodiment of the present invention;

FIG. 21 is a diagram showing complete enumeration of all the permutations in the dictionary system according to an example of the preferred embodiment of the present invention;

FIG. 22 is a diagram showing search processing in the dictionary system according to an example of the preferred embodiment of the present invention;

FIG. 23 is a diagram showing new-association processing 1 in the dictionary system according to an example of the preferred embodiment of the present invention;

FIG. 24 is a diagram showing new-association processing 2 in the dictionary system according to an example of the preferred embodiment of the present invention;

FIG. 25 is a diagram showing division processing in the dictionary system according to an example of the preferred embodiment of the present invention;

FIG. 26 is a diagram showing correspondence between a term and a unit identifier in the dictionary system according to an example of the preferred embodiment of the present invention;

FIG. 27 is a diagram showing normalization of terms constituting a document by the dictionary system according to an example of the preferred embodiment of the present invention;

FIG. 28 is a flow chart showing normalization processing of terms constituting a document in the dictionary system according to an example of the preferred embodiment of the present invention;

FIG. 29 is a flow chart showing reconfiguration processing of a dictionary in the dictionary system according to an example of the preferred embodiment of the present invention;

FIG. 30 is a diagram showing an example of registered contents in the dictionary system according to an example of the preferred embodiment of the present invention;

FIG. 31 is a diagram showing an example of registered contents in the dictionary system according to an example of the preferred embodiment of the present invention;

FIG. 32 is a diagram showing an example of a search term or a term to be searched in the dictionary system according to an example of the preferred embodiment of the present invention;

FIG. 33 is a diagram showing an example of registered contents in the dictionary system according to an example of the preferred embodiment of the present invention;

FIG. 34 is a flow chart showing partial match search processing in the dictionary system according to an example of the preferred embodiment of the present invention; and

FIG. 35 is a diagram showing an example of registered contents in the dictionary system according to an example of the preferred embodiment of the present invention.

### EXPLANATION OF REFERENCE NUMERALS

1 dictionary system
10 server
20, 20a, 20b, 20c terminal
30 communication network
60 Web site

### PREFERRED MODE FOR CARRYING OUT THE INVENTION

An example of an embodiment of the present invention is hereinafter described with reference to the drawings.

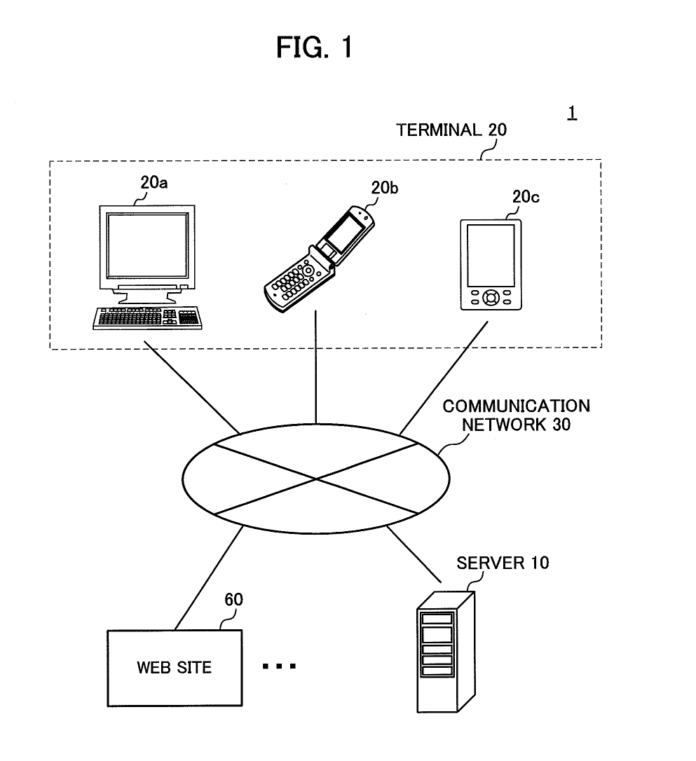

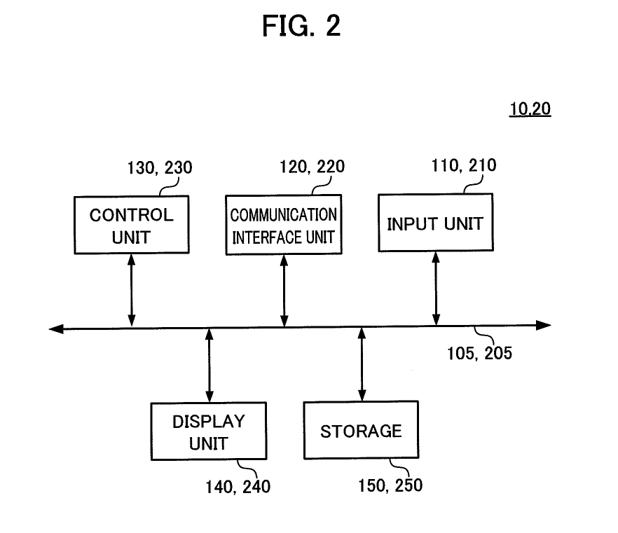

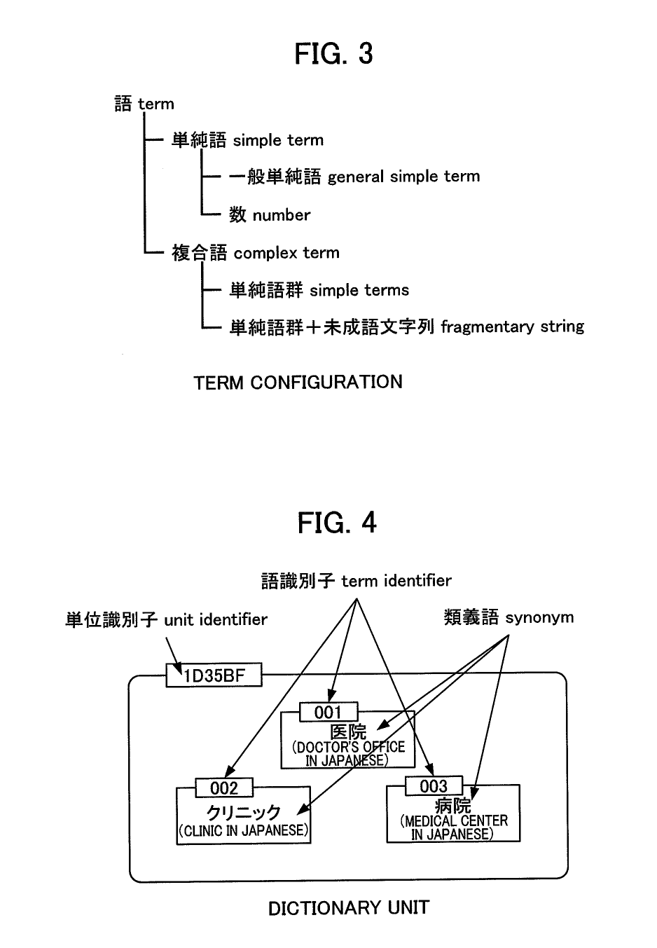

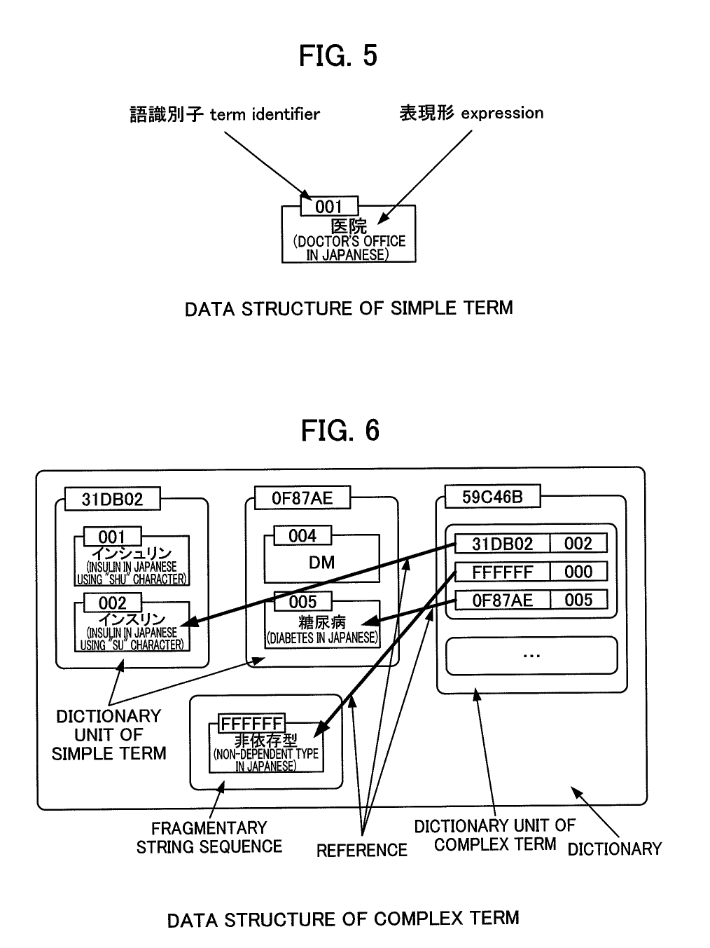

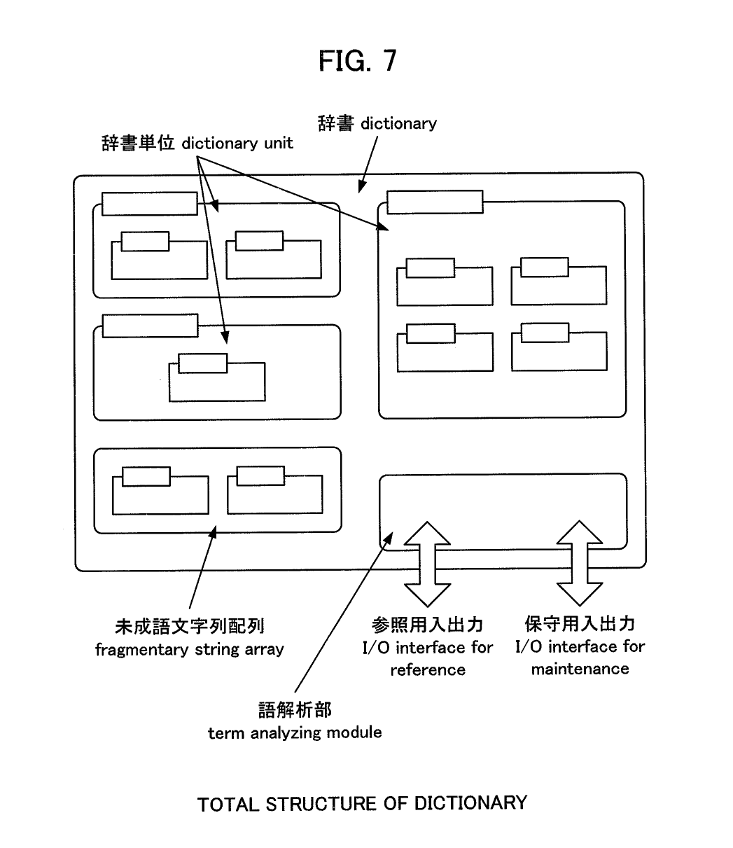

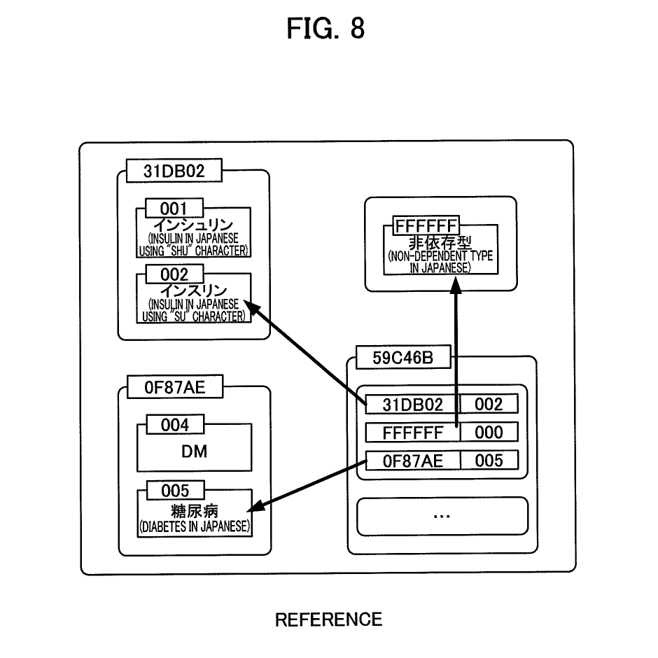

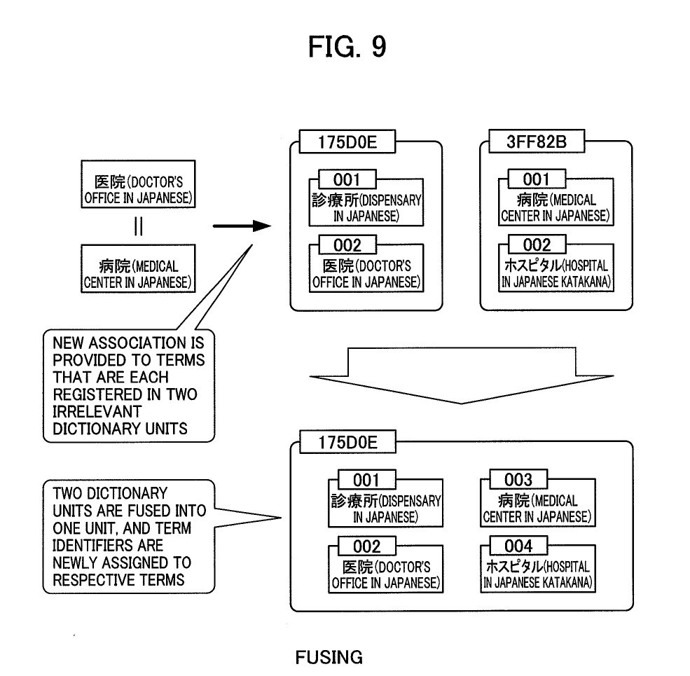

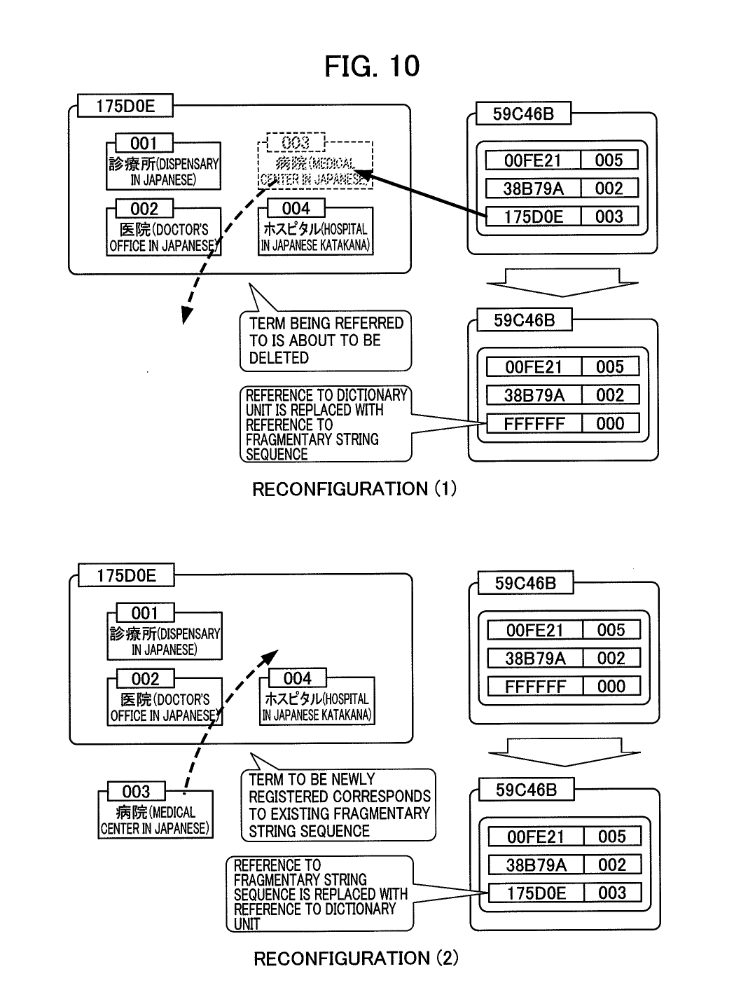

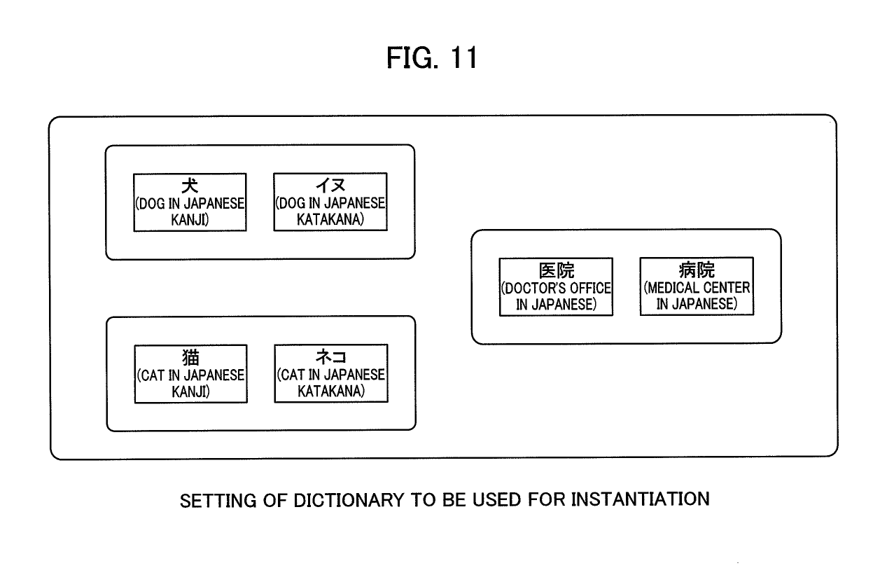

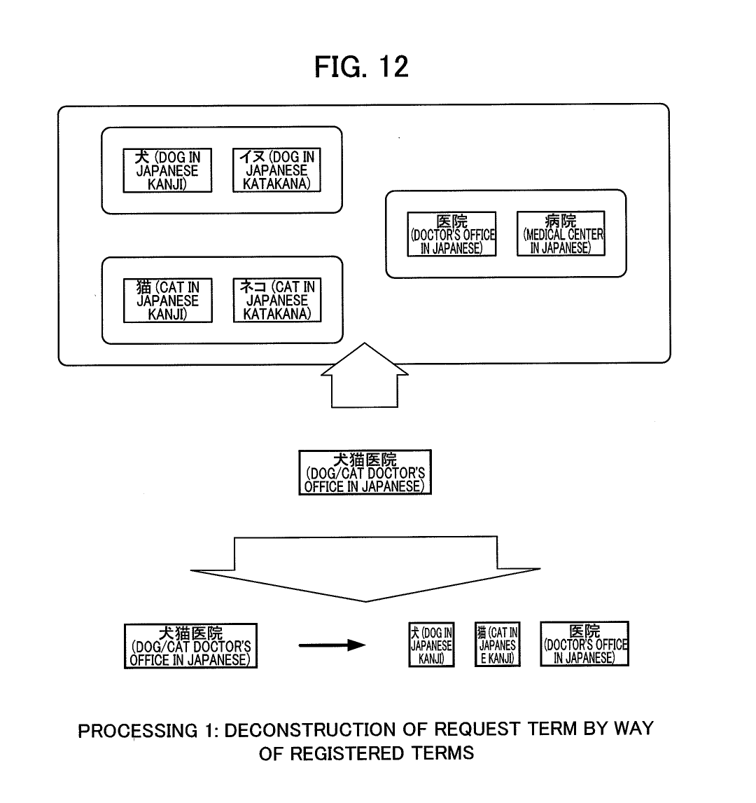

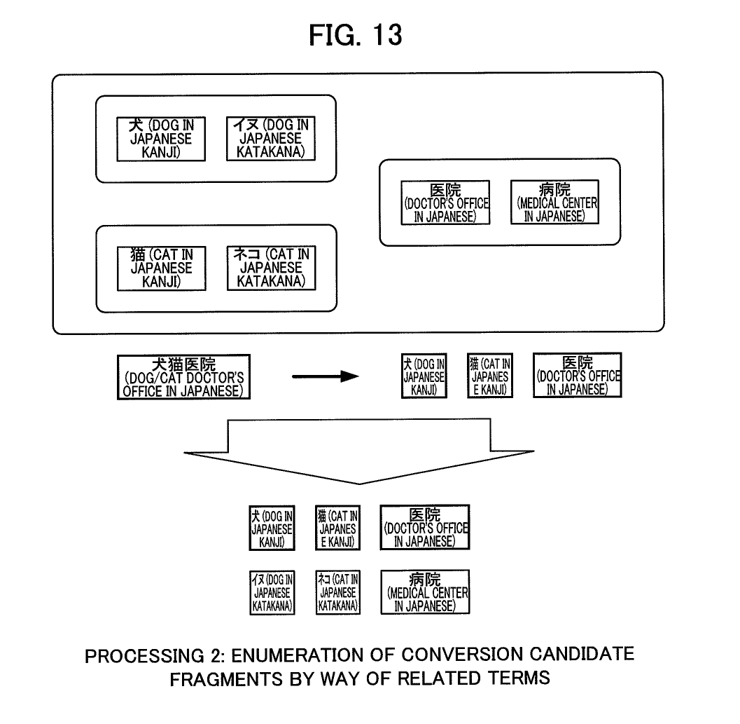

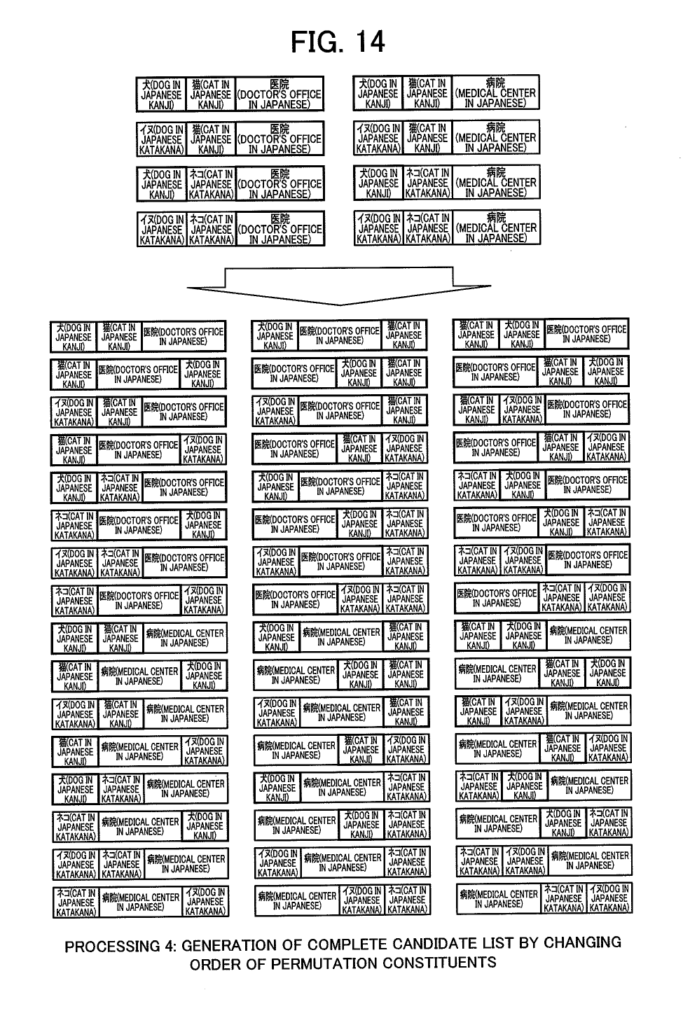

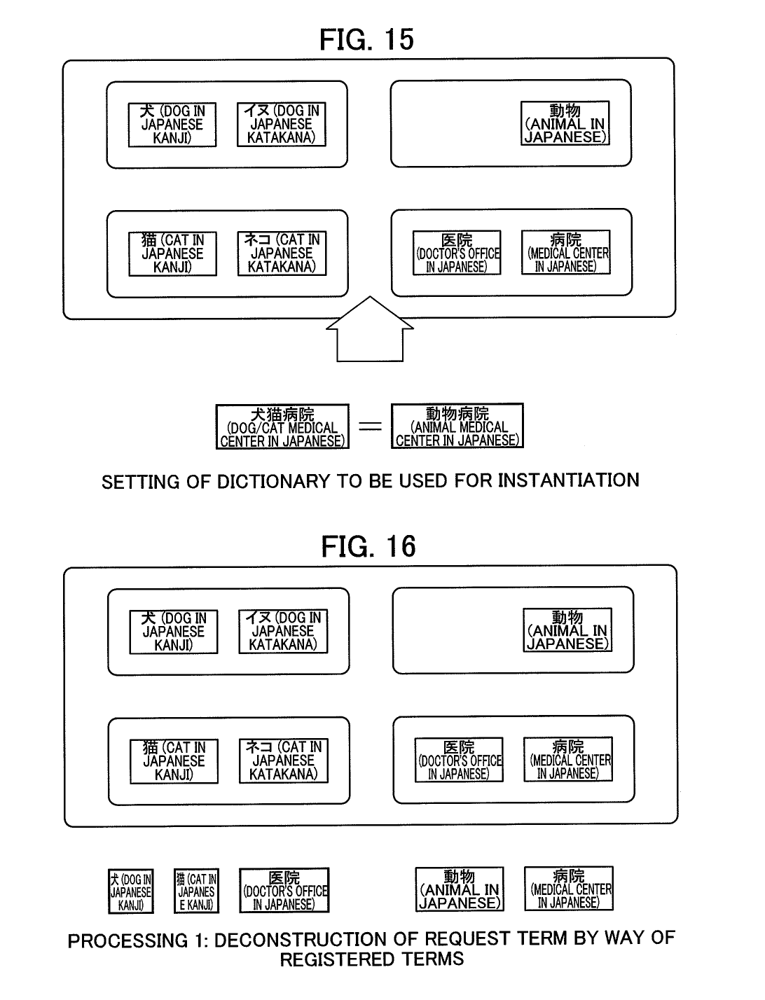

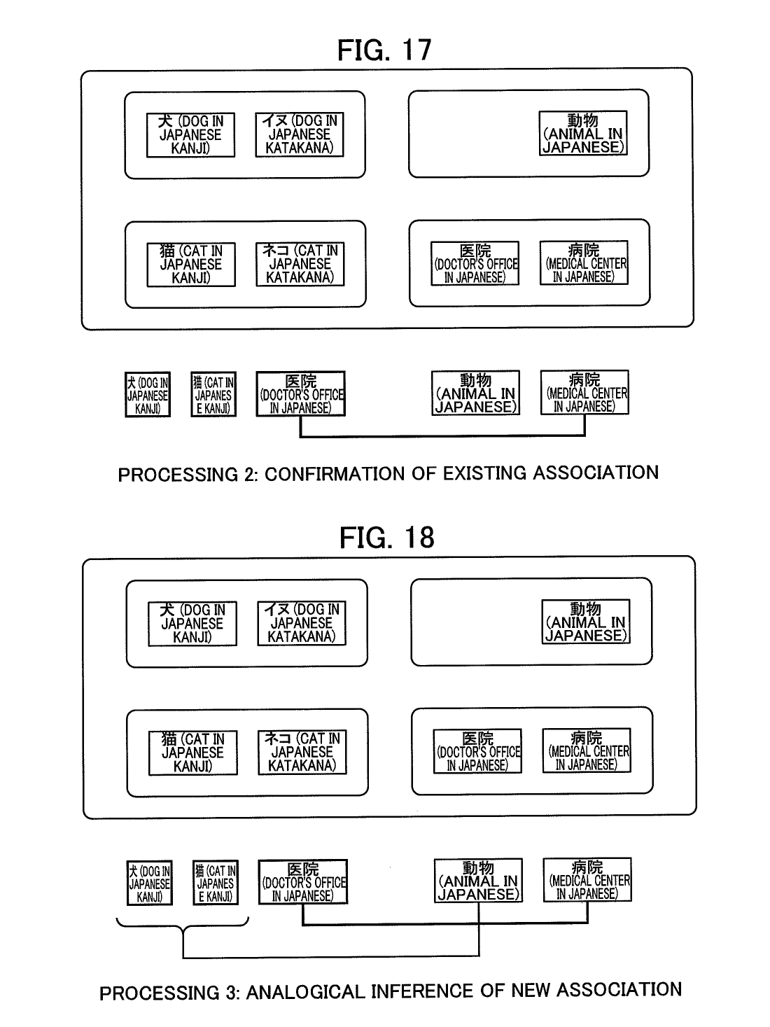

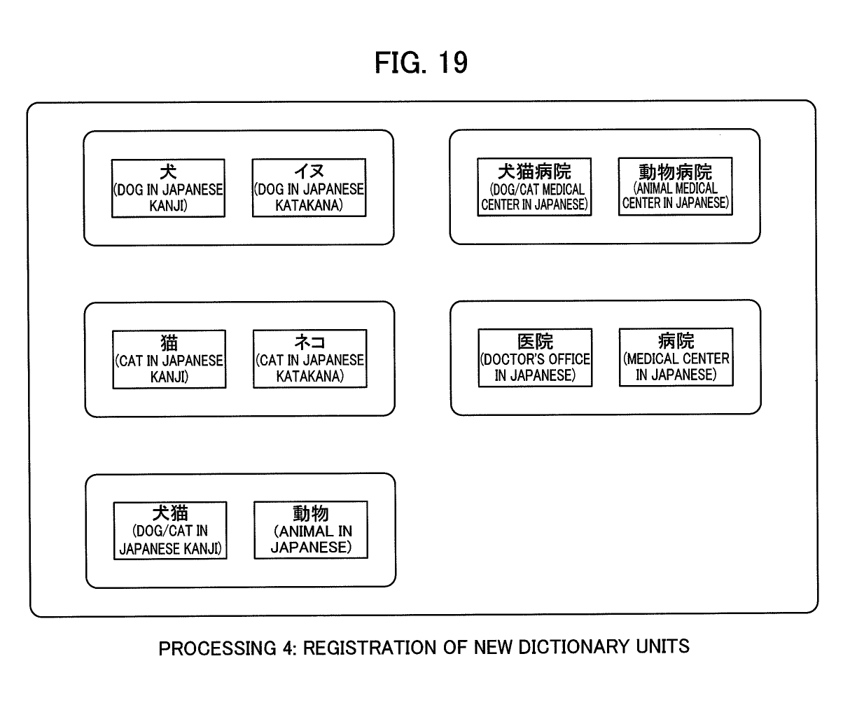

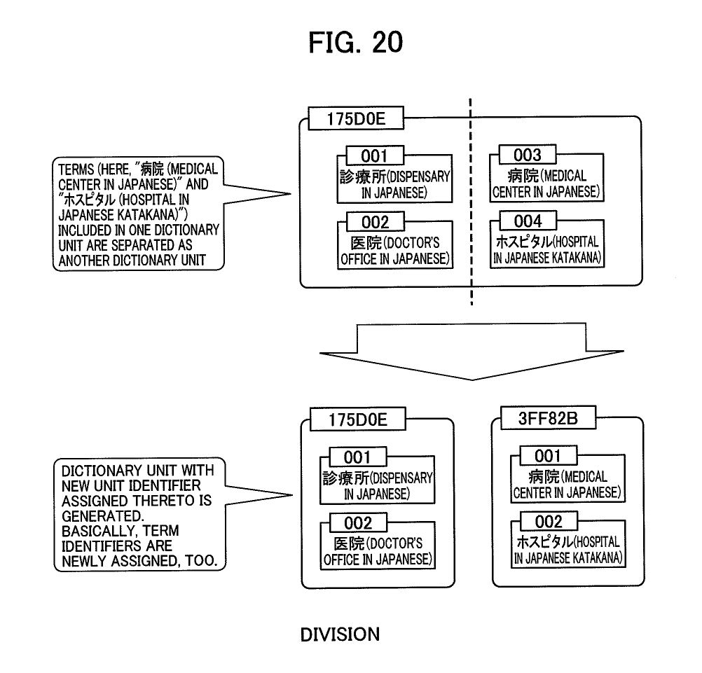

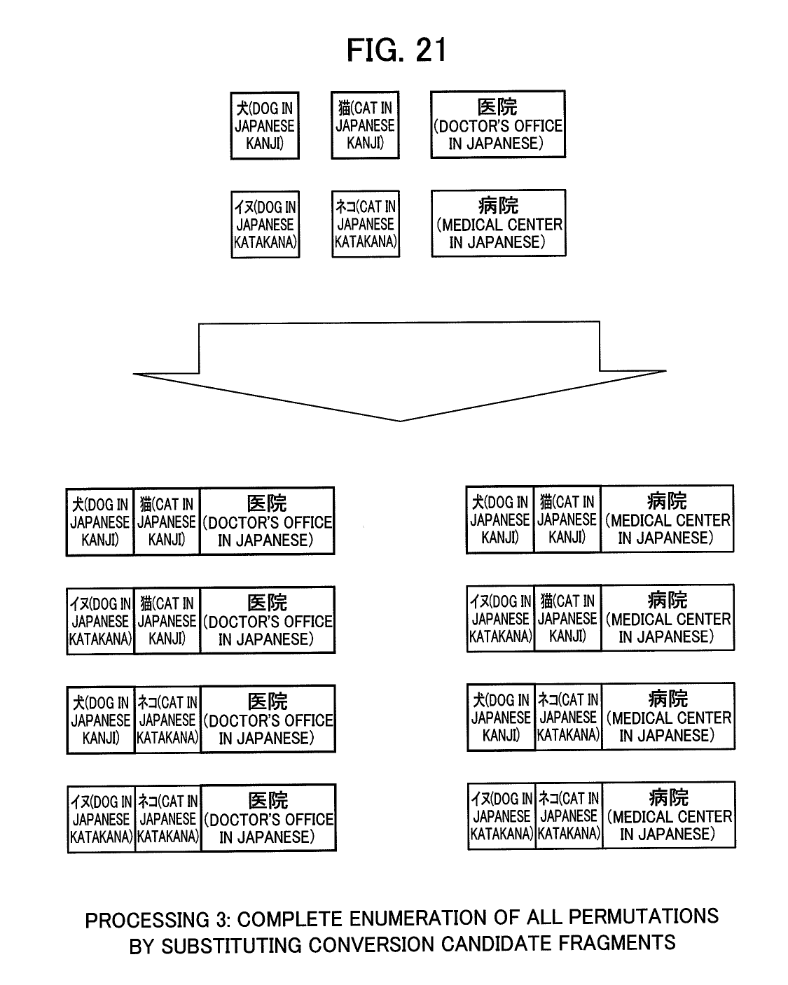

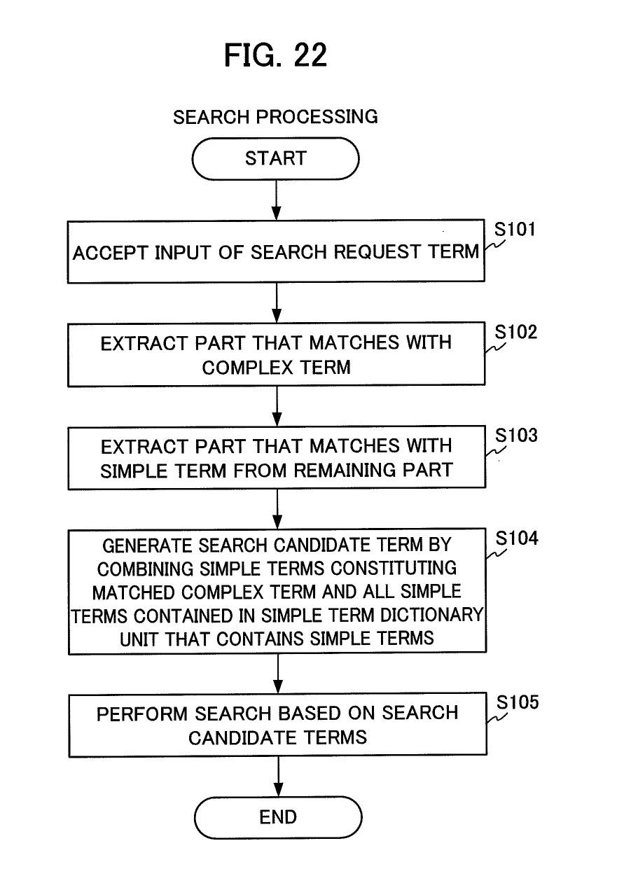

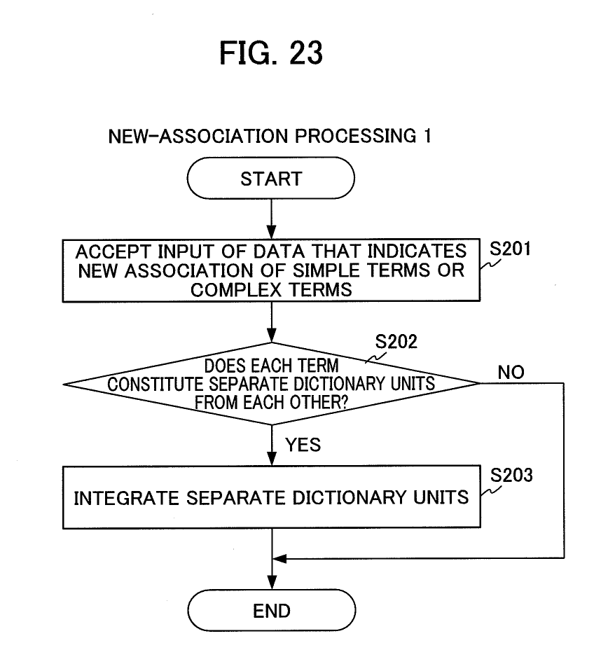

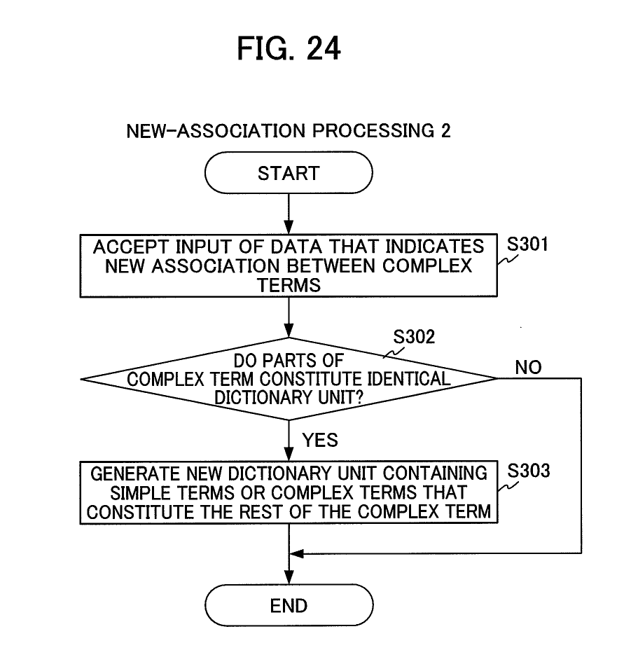

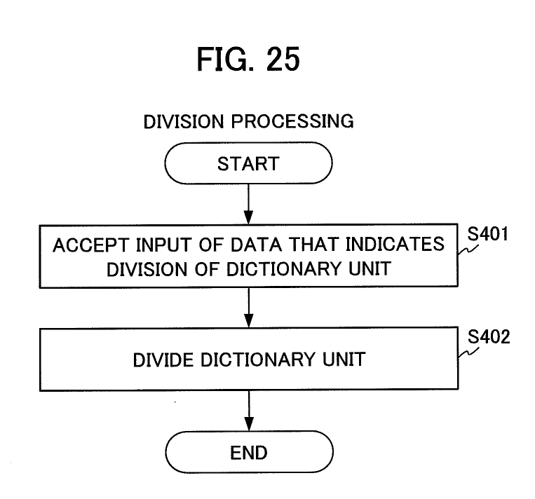

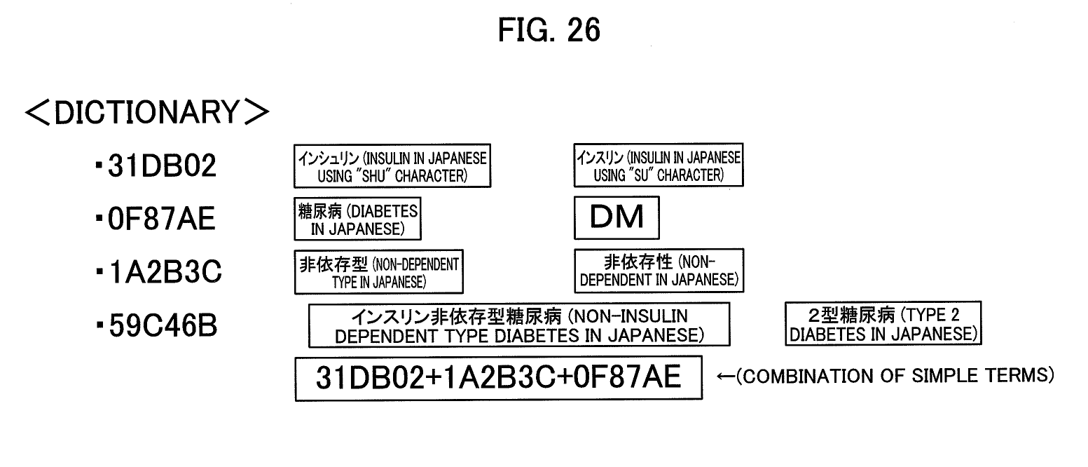

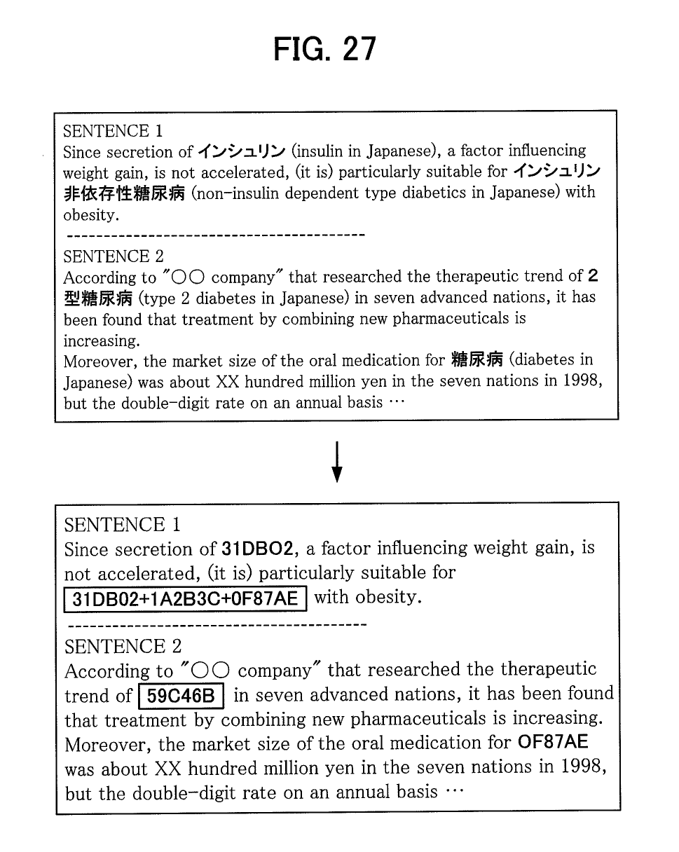

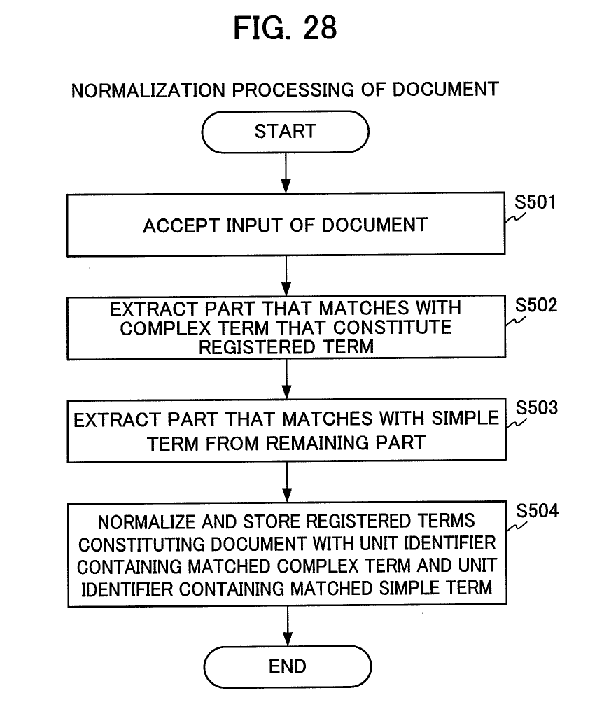

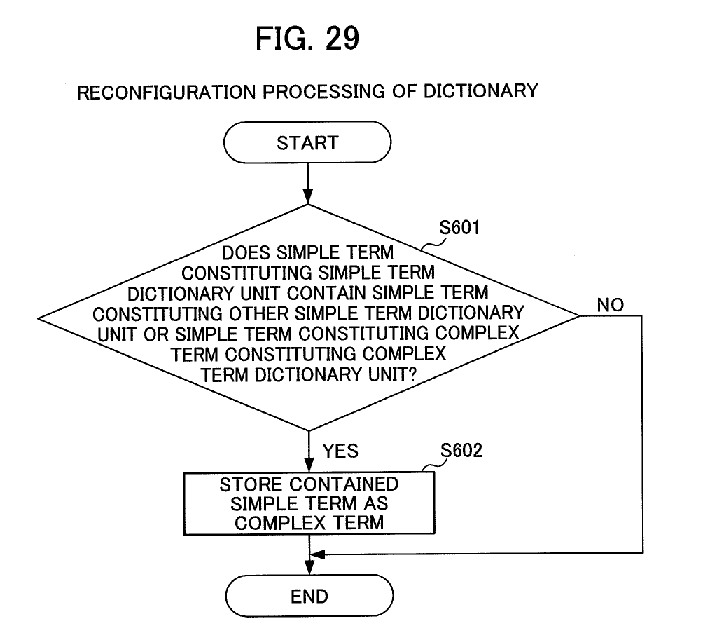

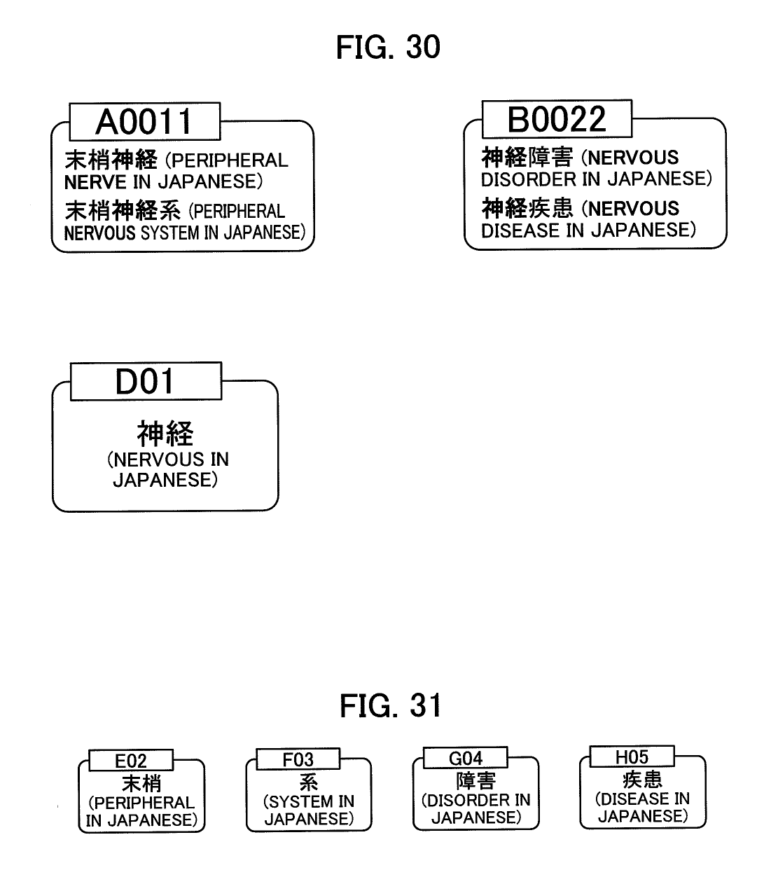

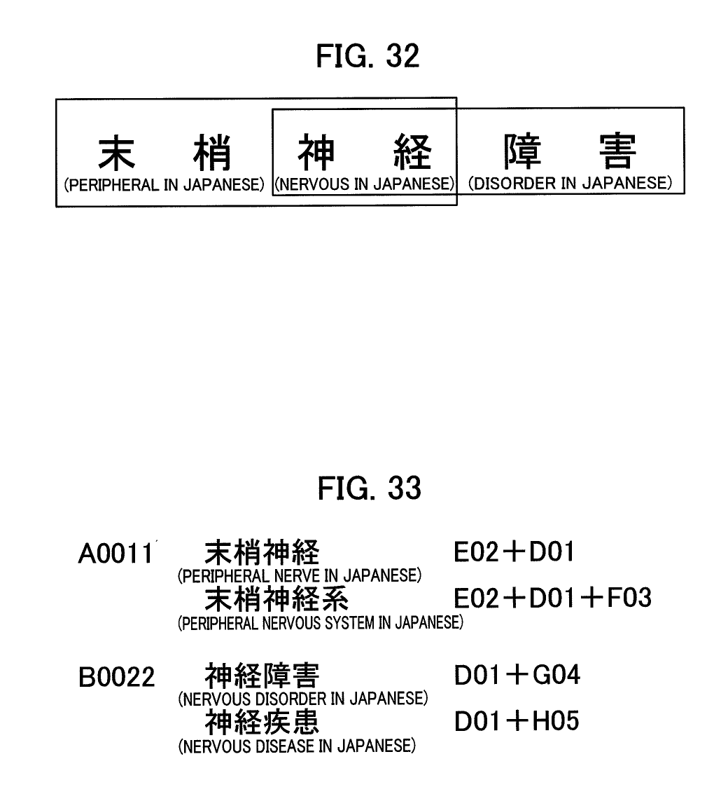

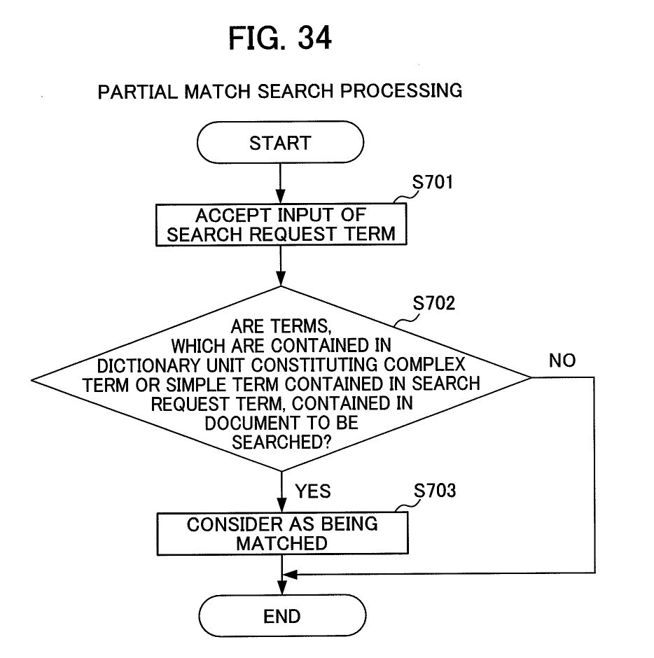

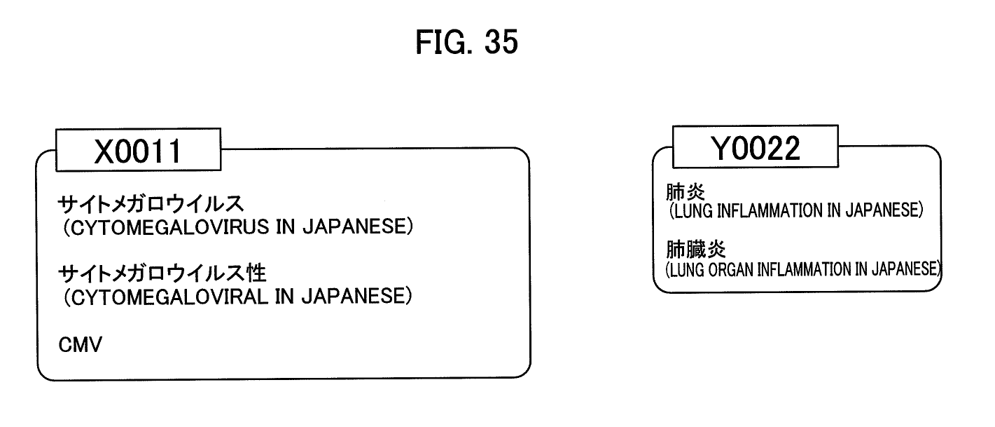

FIG. 1 is a diagram showing a total configuration of a system 1 according to an example of a preferred embodiment of the present invention. FIG. 2 is a diagram showing an example of a hardware configuration of a server 10 and a terminal 20 according to an example of the preferred embodiment of the present invention. FIG. 3 is a diagram showing a term configuration of a dictionary system according to an example of the preferred embodiment of the present invention. FIG. 4 is a diagram showing a dictionary unit in the dictionary system according to an example of the preferred embodiment of the present invention. FIG. 5 is a diagram showing a data structure of a simple term in the dictionary system according to an example of the preferred embodiment of the present invention. FIG. 6 is a diagram showing a data structure of a complex term in the dictionary system according to an example of the preferred embodiment of the present invention. FIG. 7 is a diagram showing a total structure of a dictionary in the dictionary system according to an example of the preferred embodiment of the present invention. FIG. 8 is a diagram showing reference in the dictionary system according to an example of the preferred embodiment of the present invention. FIG. 9 is a diagram showing fusion in the dictionary system according to an example of the preferred embodiment of the present invention. FIG. 10 is a diagram showing reconfiguration in the dictionary system according to an example of the preferred embodiment of the present invention. FIG. 11 is a diagram showing setting of the dictionary to be used for instantiation in the dictionary system according to an example of the preferred embodiment of the present invention. FIG. 12 is a diagram showing deconstruction of a request term by way of registered terms in the dictionary system according to an example of the preferred embodiment of the present invention. FIG. 13 is a diagram showing enumeration of conversion candidate fragments by way of related terms in the dictionary system according to an example of the preferred embodiment of the present invention. FIG. 14 is a diagram showing generation of a candidate list in the dictionary system according to an example of the preferred embodiment of the present invention. FIG. 15 is a diagram showing setting of the dictionary to be used for instantiation in the dictionary system according to an example of the preferred embodiment of the present invention. FIG. 16 is a diagram showing deconstruction of a request term by way of registered terms in the dictionary system according to an example of the preferred embodiment of the present invention. FIG. 17 is a diagram showing confirmation of an existing association in the dictionary system according to an example of the preferred embodiment of the present invention. FIG. 18 is a diagram showing analogical inference of a new association in the dictionary system according to an example of the preferred embodiment of the present invention. FIG. 19 is a diagram showing registration of new dictionary units in the dictionary system according to an example of the preferred embodiment of the present invention. FIG. 20 is a diagram showing division in the dictionary system according to an example of the preferred embodiment of the present invention. FIG. 21 is a diagram showing complete enumeration of all the permutations in the dictionary system according to an example of the preferred embodiment of the present invention. FIG. 22 is a diagram showing search processing in the dictionary system according to an example of the preferred embodiment of the present invention. FIG. 23 is a diagram showing new-association processing 2 in the dictionary system according to an example of the preferred embodiment of the present invention. FIG. 24 is a diagram showing new-association processing 2 in the dictionary system according to an example of the preferred embodiment of the present invention. FIG. 25 is a diagram showing division processing in the dictionary system according to an example of the preferred embodiment of the present invention. FIG. 26 is a diagram showing correspondence between a term and a unit identifier in the dictionary system according to an example of the preferred embodiment of the present invention. FIG. 27 is a diagram showing normalization of terms constituting a document by the dictionary system according to an example of the preferred embodiment of the present invention. FIG. 28 is a flow chart showing normalization processing of terms constituting a document in the dictionary system according to an example of the preferred embodiment of the present invention. FIG. 29 is a flow chart showing reconfiguration processing of a dictionary in the dictionary system according to an example of the preferred embodiment of the present invention. FIG. 30 is a diagram showing an example of registered contents in the dictionary system according to an example of the preferred embodiment of the present invention. FIG. 31 is a diagram showing an example of registered contents in the dictionary system according to an example of the preferred embodiment of the present invention. FIG. 32 is a diagram showing an example of a search term or a term to be searched in the dictionary system according to an example of the preferred embodiment of the present invention. FIG. 33 is a diagram showing an example of registered contents in the dictionary system according to an example of the preferred embodiment of the present invention. FIG. 34 is a flow chart showing partial match search processing in the dictionary system according to an example of the preferred embodiment of the present invention. FIG. 35 is a diagram showing an example of registered contents in the dictionary system according to an example of the preferred embodiment of the present invention.

FIG. 1 is a diagram showing a total configuration of a system 1 according to an example of a preferred embodiment of the present invention.

In a system 1 of the present embodiment, a server 10 is configured to be able to connect to a terminal 20 and a web site 60 through a communication network 30.

The server 10 accepts or collects document data (for example, a web page on the Internet or intranet) containing text, images, etc., and stores it. Furthermore, the server 10 analyzes document data, extracts term data, and stores it as a dictionary system. In addition, it has a function to transmit the result of the search of the stored term data, that is performed in response to a search request of the user from, for example, a web browser of the terminal 20, etc. There is no restriction in the number of the hardware of the server 10, and it may be configured with one or more hardware as may be necessary.

The web site 60 stores document data (for example, web page data), and has a function to transmit the data to the terminal 20 through a communication network 30 such as the Internet, etc. It is noted that a place on the Internet that manages a group of web page data of, for example, a web page, etc., of an individual or an enterprise, or a group of web page data is called a “web site”.

The communication network 30 connects the server 10, the web site 60, and the terminal 20. It is noted that the communication network 30 may be implemented through wired media but it may be implemented through various communication networks, etc., as long as it accords with the technical idea of the present invention. For example, a communication network that partially uses wireless using base stations, such as mobile phones, etc., communication network that uses wireless LAN via access points may be used.

Besides a PC (Personal Computer) 20a, the terminal 20 may be a communication terminal other than so-called computers, such as a mobile phone 20b and a PDA (Personal Data Assistant) 20c, etc.

### [Hardware Configuration of the Server 10]

It is noted that the dictionary system 1 may be configured to execute intensively information processing by software, which is to be described later, at the terminal 20 and to exert all the functions in a stand-alone form. Moreover, the dictionary system 1 realized in a stand-alone form in the terminal 20 may constitute a document management apparatus having a search capability or a normalization capability, by further including a document to be subjected to the search (searching document). Alternatively, it may be constituted as a collection of documents by combining software and documents (documents to be searched) to be subjected to the search.

FIG. 2 is a diagram showing an example of a hardware configuration of a server 10 and a terminal 20 according to an example of the preferred embodiment of the present invention. As shown in FIG. 2, an input unit 110, a communication interface unit 120, a control unit 130, a display unit 140, and a storage 150 are connected via a bus line 105 to constitute the server 10.

The input unit 110 can be implemented with an input device, such as a mouse and a keyboard, etc. Moreover, the communication interface unit 120 can be implemented by, for example, a LAN adapter and a modem adapter, etc. Furthermore, the control unit 130 can be configured by a CPU (Central Processing Unit) and controls the overall server 10 and realizes various processing to be described later by reading and executing a program stored in the storage 150. Moreover, the display unit 140 can be implemented by, for example, a liquid crystal display (LCD) or a cathode-ray tube display (CRT), etc. Furthermore, the storage 150 can be implemented by, for example, a hard disk and semiconductor memories, etc.

Although the above example has been described mainly with respect to the server 10, the above described function can also be implemented by installing a program in a computer and operating the computer as a server device. Therefore, the function realized by the server 10 described as an embodiment of the present invention can be implemented also by performing the above procedure with the computer, or alternatively, installing the above program in the computer and executing it.

### [Hardware Configuration of the Terminal 20]

The terminal 20 herein may have the same configuration as the above server 10. It is noted that the input unit 210, the communication interface unit 220, the control unit 230, the display 240, and the storage 250 are connected by the bus line 205 to form the terminal 20.

FIG. 3 is a diagram showing a term configuration of a dictionary system according to an example of the preferred embodiment of the present invention. A string that constitutes a dictionary and that has unity is called a “term”. As for terms, there are simple terms and complex terms. All terms are subjected to be registered in the dictionary system.

Here, in a dictionary system, a “simple term” is a term that cannot be divided any more because there is no divided term in the dictionary. Specifically, examples of the simple term include “ [symbol] (dog in Japanese kanji)”, “ [symbol] (dog in Japanese katakana)”, “ [symbol] (cat in Japanese kanji)”, “ [symbol] (cat in Japanese katakana)”, “ [symbol] (doctor's office in Japanese)”, and “ [symbol] (clinic in Japanese)”, etc. A number is treated as a special simple term. Specifically, examples of the numbers include “123”, and “123,456”, etc.

Moreover, a “complex term” refers to a chained set of one or more simple terms or combination of simple term(s) and fragmentary string(s) (a string that is not registered as a term). The distinction between the simple term and the complex term depends on dictionary operation as will be described below, and a simple term becomes a complex term easily and a complex term becomes a simple term easily.

FIG. 4 is a diagram showing a dictionary unit in the dictionary system according to an example of the preferred embodiment of the present invention. A dictionary unit contains one or more terms. Each dictionary unit is associated with a unit identifier, and a dictionary unit is referred to from outside using the unit identifier as a pointer, as will be described later.

The terms that constitute a dictionary unit represent that they are in a synonymous relation with each other. In this example, “ [symbol] (doctor's office in Japanese)”, “ [symbol] (clinic in Japanese)”, and “ [symbol] (medical center in Japanese)” that are terms that are contained in a dictionary unit associated with a unit identifier “1D35BF” are defined as synonymous terms with each other. Moreover, each term is associated with a term identifier. That is, in this example, “ [symbol] (doctor's office in Japanese)”, “ [symbol] (clinic in Japanese)”, and “ [symbol] (medical center in Japanese)” are associated with term identifiers, “001”, “002” and “003”, respectively, and are referred to from outside using the term identifiers as pointers. For example, a term “ [symbol] (doctor's office in Japanese)” can be referred to using a pointer, “1D35BF” “001”, that consist of a unit identifier and a term identifier.

FIG. 5 is a diagram showing a data structure of a simple term in the dictionary system according to an example of the preferred embodiment of the present invention. As described above, in a dictionary system, a “simple term” is a term that cannot be divided any more because there is no divided term in the dictionary. This example shows that a simple term “ [symbol] (doctor's office in Japanese)” can be identified by using a term identifier “001” as a pointer.

FIG. 6 is a diagram showing a data structure of a complex term in the dictionary system according to an example of the preferred embodiment of the present invention. In this example, a “complex term” that is referred to from the outside using a unit identifier “59C46B” as a pointer is defined so that it contains a sequence of identifiers that contains unit identifiers and term identifiers, “31DB02(002)+FFFFFF(000)+0F87AE (005).” Furthermore, a simple term dictionary unit referred to using a unit identifier “31DB02” further contains “ [symbol] (insulin (using “SHU” character) in Japanese)” that is referred to using a term identifier “001”, and also “ [symbol] (insulin (using “SU” character) in Japanese)” that is referred to using a term identifier “002.” That is, these are defined as synonyms. Moreover, a fragmentary string sequence, “ [symbol] (non-dependent type in Japanese)”, that is referred to using a unit identifier “FFFFFF” is defined. Similarly, a simple term dictionary unit referred to using a unit identifier “0F87AE” further contains “DM” that is referred to using a term identifier “004”, and “ [symbol] (diabetes in Japanese) that is referred to using a term identifier “005.” In this example, a term “ [symbol] [symbol] (non-insulin (using “SU” character) dependent type diabetes in Japanese)” is defined by these definitions.

Thus, as described above, it is defined that synonyms, “ [symbol] [symbol] DM (non-insulin (using “SU” character) dependent type DM in Japanese)”, “ [symbol] [symbol] (non-insulin (using “SHU” character) dependent type diabetes in Japanese)”, and “ [symbol] [symbol] DM (non-insulin (using “SHU” character) dependent type DM in Japanese)” exist for the term “ [symbol] [symbol] (non-insulin (using “SU” character) dependent type diabetes in Japanese)” that is referred to using a unit identifier “59C46B”, and they can be used as search candidate terms at the time of search.

FIG. 7 is a diagram showing a total structure of a dictionary in the dictionary system according to an example of the preferred embodiment of the present invention. As described above, a dictionary system contains dictionary units and fragmentary string sequences, and contains a term analyzing module that includes an I/O interface for reference and an I/O interface for maintenance.

By means of the I/O interface for reference, the dictionary system includes: a means for accepting a search request term; a means for extracting a part that matches with the complex term from the accepted search request term; a means for extracting a part that matches with the simple term from the rest; and a means for generating a search candidate term by combining a simple term that constitutes the matched complex term, and all of the simple terms contained in simple term dictionary unit(s) that contains the matched simple term.

FIG. 8 is a diagram showing reference in the dictionary system according to an example of the preferred embodiment of the present invention. As described above, this example shows a reference to a term “ [symbol] [symbol] (non-insulin (using “SU” character) dependent type diabetes in Japanese)”.

FIG. 22 is a diagram showing search processing in the dictionary system according to an example of the preferred embodiment of the present invention.

First, the control unit 230 of the terminal 20 accepts an input of a search request term (Step S101). It is noted that the server 10 may accept the input directly. The terminal 20 transmits data indicating the search request term to the server 10 via the communication network 30.

Then, the control unit 130 of the server 10 analyzes the accepted search request term, refers to the dictionary stored in the storage 150, and extracts the part that matches with the complex term (Step S102).

Thereafter, the control unit 130 of the server 10 extracts the part of the remaining part that matches with the simple term (Step S103).

Then, the control unit 130 of the server 10 generates the search candidate term by combining the simple term that constitutes the matched complex term and all the simple terms contained in the simple term dictionary unit that the simple term contains (Step S104).

Thereafter, the control unit 130 of the server 10 searches for the search target document (for example, document that the web site 60 manages) based on the search candidate term (Step S105).

For example, if the control unit 130 accepts an input of “ [symbol] [symbol] (non-insulin (using “SU” character) dependent type diabetes in Japanese)” that is referred to using a unit identifier “59C46B” as the search request term as described above, synonyms, “ [symbol] [symbol] (non-insulin (using “SU” character) dependent type DM in Japanese)”, “ [symbol] [symbol] (non-insulin (using “SHU” character) dependent type diabetes in Japanese)”, and “ [symbol] [symbol] (non-insulin (using “SHU” character) dependent type DM in Japanese)” are automatically generated as the search candidate term, to thereby enable the search for the search target document. Furthermore, the order of the simple terms may be replaced for generating as the search candidate term.

Alternatively, if the search request term is any one of the above synonyms, the control unit 130 may replace all the parts in the searching document having the above synonyms with the unit identifier “59C46B”, use the unit identifier “59C46B” as the search request term, and compare between the unit identifiers to perform the search. Alternatively, in the example shown in FIG. 6, it may be replaced with a sequence of unit identifiers “31DB02+FFFFFF+0F87AE” to compare between the unit identifiers to perform the search.

Thus, the control unit 130 can effectively perform a search that covers the registered synonyms without losing precision by referring to a complex term “ [symbol] [symbol] (non-insulin (using “SU” character) dependent type diabetes in Japanese)” through a unit identifier “59C46B” or a sequence of unit identifiers “31DB02+FFFFFF+0F87AE”.

Moreover, by means of the I/O interface for maintenance, the dictionary system includes: a means for accepting an input of data that indicates a new association of a simple term or a complex term; a means for integrating (fusing), if a simple term or a complex term to which the new association is indicated is constituting a different dictionary unit; a means for accepting an input of data that indicates a new association between the complex terms; a means that, if a part of the complex term to which a new association is indicated is constituting the same dictionary unit, analogizes that combinations of the simple term or the complex term that constitutes the rest are associated with each other, for generating a new dictionary unit containing a simple term or a complex term that constitutes the rest; a means for accepting an input of data that indicates a division of a dictionary unit that constitutes to contain a plurality of simple terms or complex terms; and a means for dividing the dictionary unit based on data that indicates the accepted division.

FIG. 9 is a diagram showing fusion in the dictionary system according to an example of the preferred embodiment of the present invention. In this example, there is defined a new dictionary unit “175D0E” by accepting data that indicates association between “ [symbol] (doctor's office in Japanese)” and “ [symbol] (medical center in Japanese)” and by integrating (fusing) dictionary units “175D0E” and “3FF82B” that both of the terms constitute. In this case, term identifiers are newly assigned for each term.

FIG. 23 is a diagram showing new-association processing 1 in the dictionary system according to an example of the preferred embodiment of the present invention.

First, the control unit 230 of the terminal 20 accepts an input of data that indicates a new association of a simple term or a complex term (Step S201). It is noted that the server 10 may accept the data directly. The terminal 20 transmits the data that indicates the new association to the server 10 via the communication network 30.

Then, the control unit 130 of the server 10 refers to the dictionary stored in the storage 150 based on each term contained in the accepted data and determines whether or not each of the terms constitutes a separate dictionary unit from each other (Step S202).

Thereafter, the control unit 130 of the server 10 integrates the separate dictionary units if the determination in Step S202 is true (Step S203). In the example of FIG. 9, since “ [symbol] (doctor's office in Japanese)” and “ [symbol] (medical center in Japanese)” constitute dictionary units “175D0E” and “3FF82B”, respectively, both dictionary units are integrated in a new dictionary unit “175D0E.”

FIG. 10 is a diagram showing reconfiguration in the dictionary system according to an example of the preferred embodiment of the present invention. First, in the example of Reconfiguration (1), “ [symbol] (medical center in Japanese)”, which is a simple term that constitutes a complex term associated with a unit identifier “59C46B” is referred to using a unit identifier “175D0E” as a pointer and also a term identifier “003” as a pointer. Here, if the term “ [symbol] (medical center in Japanese)” is to be deleted from the dictionary unit, since “ [symbol] (medical center in Japanese)” is no longer a term that is contained in the dictionary unit, that is, it becomes a fragmentary string, the corresponding portion is replaced with a reference to a fragmentary string “FFFFFF 000”.

Moreover, the example of Reconfiguration (2) is opposite to the above example, and upon newly registering “ [symbol] (medical center in Japanese)” that had been originally being referred to as a fragmentary string into a dictionary unit, the corresponding part of the dictionary unit that contains the complex term referring to it is also replaced the unit identifier for the newly registered dictionary unit so as to be referred to as a pointer.

FIGS. 11 to 14 and 21 are diagrams showing examples of generative processing of search candidate terms in a case in which an input of a search request term has been accepted, in the dictionary system according to an example of the preferred embodiment of the present invention.

First, as shown in FIG. 11, a case is considered in which “ [symbol] (dog in Japanese kanji)” and “ [symbol] (dog in Japanese katakana)”, “ [symbol] (cat in Japanese kanji)” and “ [symbol] (cat in Japanese katakana)”, and “ [symbol] (doctor's office in Japanese)” and “ [symbol] (medical center in Japanese)” are set in three dictionary units, respectively.

Here, as shown in FIG. 12, in a case in which “ [symbol] (dog/cat doctor's office in Japanese)” is given as a search request term, it is deconstructed into registered terms “ [symbol] (dog in Japanese kanji)”, “ [symbol] (cat in Japanese kanji)” and “ [symbol] (doctor's office in Japanese)”.

Next, as shown in FIG. 13, by referring to dictionary units each containing registered terms, it is understood that “ [symbol] (dog in Japanese kanji)” is a synonym for “ [symbol] (dog in Japanese katakana)”, “ [symbol] (cat in Japanese kanji)” is a synonym for “ [symbol] (cat in Japanese katakana)”, and “ [symbol] (medical center in Japanese)” is a synonym for “ [symbol] (doctor's office in Japanese)”.

Next, as shown in FIG. 21, all the permutations of these synonyms are expanded. As for this example, they are expanded to 2×2×2=8 kinds.

Then, as shown in FIG. 14, a complete candidate list is generated by changing the order of each permutation.

FIGS. 15 to 19 are diagrams showing examples of reconfiguration processing of a dictionary in a case in which a new association between complex terms has been given, in the dictionary system according to an example of the preferred embodiment of the present invention.

Furthermore, FIG. 24 is a diagram showing new-association processing 2 (reconfiguration of a dictionary) in the dictionary system according to an example of the preferred embodiment of the present invention.

First, the control unit 230 of the terminal 20 accepts an input of data that indicates a new association between complex terms (Step S301). It is noted that the server 10 may accept the input directly. The terminal 20 transmits the data that indicates the new association to the server 10 via the communication network 30.

Then, the control unit 130 of the server 10 determines whether or not parts of the accepted complex term constitute the same dictionary unit (Step S302).

Thereafter, if the determination in Step S302 is true, the control unit 130 of the server 10 generates a new dictionary unit containing the simple term or the complex term that constitutes the rest (Step S303). This will be described below using a specific example.

A case is considered in which data indicating that complex terms, “ [symbol] (dog/cat doctor's office in Japanese) and “ [symbol] (animal medical center in Japanese), are associated is accepted in a dictionary shown in FIG. 15.

In this case, as shown in FIG. 16, the two complex terms are deconstructed into registered terms, “ [symbol] (dog in Japanese kanji)”, “ [symbol] (cat in Japanese kanji)” and “ [symbol] (doctor's office in Japanese)”, and “ [symbol] (animal in Japanese kanji)” and “ [symbol] (medical center in Japanese)”.

Then, as shown in FIG. 17, it is confirmed that “ [symbol] (doctor's office in Japanese)” and “ [symbol] (medical center in Japanese)” constitute the same dictionary unit.

Then, as shown in FIG. 18, “ [symbol] (dog in Japanese kanji)”, “ [symbol] (cat in Japanese kanji), and “ [symbol] (animal in Japanese kanji) are registered in order to constitute a new dictionary unit as shown in FIG. 19. Specifically, a dictionary unit constituted with “ [symbol] (dog/cat in Japanese kanji) and “ [symbol] (animal in Japanese kanji) and a dictionary unit constituted with “ [symbol] (dog/cat doctor's office in Japanese) and “ [symbol] (animal medical center in Japanese) are newly generated and registered.

FIG. 25 is a diagram showing division processing in the dictionary system according to an example of the preferred embodiment of the present invention.

First, the control unit 230 of the terminal 20 accepts an input of data that indicates division of a dictionary unit (Step S401). It is noted that the server 10 may accept the input directly. The terminal 20 transmits the data that indicates division to the server 10 via the communication network 30.

Then, the control unit 130 of the server 10 divides a dictionary unit based on the accepted data that indicates division (Step S402). This will be described below using a specific example.

FIG. 20 is a diagram showing division in the dictionary system according to an example of the preferred embodiment of the present invention. In this example, data that indicates division of “ [symbol] (medical center in Japanese)” and “ [symbol] (hospital in Japanese katakana)”, which constitutes a dictionary unit that is referred to using a single unit identifier “175D0E” as a pointer, is accepted.

Then, the system generates and registers a new dictionary unit that includes “ [symbol] (medical center in Japanese)” and “ [symbol] (hospital in Japanese katakana)”, which are subjected to the division, and refers to a unit identifier “3FF82B” as a pointer.

FIG. 26 is a diagram showing correspondence between a term and a unit identifier in the dictionary system according to an example of the preferred embodiment of the present invention.

In this example, a dictionary unit that is referred to using a unit identifier “31DB02” contains a registered term “ [symbol] (insulin (using “SHU” character) in Japanese)” and a registered term “ [symbol] (insulin (using “SU” character) in Japanese), a dictionary unit that is referred to using a unit identifier “0F87AE” contains a registered term “ [symbol] (diabetes in Japanese)” and a registered term “DM”, and a dictionary unit that is referred to using a unit identifier “1A2B3C” contains a registered term “ [symbol] (non-dependent type in Japanese) and a registered term “ [symbol] (non-dependent in Japanese).” If a dictionary unit that is referred to using a unit identifier “59C46B”, which includes “ [symbol] [symbol] (non-insulin (using “SU” character) dependent type diabetes in Japanese)” and “ [symbol] (type 2 diabetes in Japanese) as registered terms, is newly registered, as described above, a new dictionary having a registered term “ [symbol] (type 2 in Japanese)”, and registered terms “ [symbol] [symbol] (non-insulin (using “SHU” character) dependent in Japanese), “ [symbol] [symbol] (non-insulin (using “SHU” character) dependent type in Japanese), “ [symbol] [symbol] (non-insulin (using “SU” character) dependent in Japanese)”, and “ [symbol] [symbol] (non-insulin (using “SU” character) dependent type in Japanese)” is created automatically (not illustrated). In this case, the registered term “ [symbol] [symbol] (non-insulin (using “SU” character) dependent type diabetes in Japanese)” can be replaced with a sequence of unit identifiers, “31DB02+1A2B3C+0F87AE”.

FIG. 27 is a diagram showing normalization of terms constituting a document in an example in FIG. 26.

In this example, a registered term “ [symbol] (insulin (using “SHU” character) in Japanese)” is replaced with a unit identifier “31DB02”, a registered term “ [symbol] [symbol] non-insulin (using “SHU” character) dependent diabetes” is replaced with a sequence of unit identifiers “31DB02+1A2B3C+0F87AE”, a registered term “ [symbol] (type 2 diabetes in Japanese)” is replaced with a unit identifier “59C46B”, and a registered term “ [symbol] (diabetes in Japanese)” is replaced with a unit identifier “0F87AE.” Thus, even in cases where a part of a complex term registered in a unit identifier “59C46B” (“ [symbol] (insulin (using “SU” character) in Japanese)” and “ [symbol] (non-dependent type in Japanese)”) does not match with a term in a searching document (“ [symbol] (insulin (using “SHU” character) in Japanese)” and “ [symbol] (non-dependent in Japanese)”, they can be normalized uniquely by referring to other dictionary units (31DB02, 1A2B3C) containing the term that constitutes a complex term.

Furthermore, by replacing registered terms contained in a dictionary system 1 with corresponding unit identifiers as described above, it is possible to normalize terms that constitute a searching document. By performing such normalization, it is possible to express a registered synonym by a single unit identifier, and efficient search can be performed without losing precision by performing later search processing by referring and comparing the unit identifiers with each other.

In this example, a registered term “ [symbol] [symbol] (non-insulin (using “SHU” character) dependent diabetes in Japanese)” contained in Document 1 and a registered term “ [symbol] (type 2 diabetes in Japanese)” contained in Document 2 can be replaced with a sequence of unit identifiers “31DB02+1A2B3C+0F87AE” and a unit identifier “59C46B”, respectively, and therefore, by referring a dictionary unit of a complex term using a unit identifier “59C46B”, it is possible to confirm that they are in a synonymous relation with each other.

Although “ [symbol] [symbol] (non-insulin (using “SHU” character) dependent diabetes in Japanese)” is replaced with “31DB02+1A2B3C+0F87AE” and “ [symbol] (type 2 diabetes in Japanese)” is replaced with “59C46B” in this example, both of them may be replaced with “31DB02+1A2B3C+0F87AE” instead. By performing such normalization, it is possible to confirm that they are in a synonymous relationship with each other in later search processing, without referring to the complex term dictionary unit. Moreover, by performing such replacement, it is possible to check that a registered term “ [symbol] (insulin (using “SHU” character) in Japanese)” referred to using a unit identifier “31DB02” partly matches with a registered term “ [symbol] [symbol] (non-insulin (using “SHU” character) dependent diabetes in Japanese)” and a registered term “ [symbol] (type 2 diabetes in Japanese)” through a unit identifier “31DB02.” The above search precision will be guaranteed since even if the registered term “ [symbol] (insulin (using “SHU” character) in Japanese)” (unit identifier “31DB02”, term identifier “001”) is a registered term “ [symbol] (insulin (using “SU” character) in Japanese)” (unit identifier “31DB02”, term identifier “002”), it is replaced with a unit identifier “31DB02” likewise, and therefore, it is possible to confirm that they are synonymous terms.

FIG. 28 is a flow chart showing normalization processing of terms constituting a document in the dictionary system according to an example of the preferred embodiment of the present invention.

First, the control unit 130 accepts an input of a document to be normalized (Step S501). Here, the control unit 130 may accept the input via the communication network 30, or by the input unit 110 accepting an input operation by a user.

Then, the control unit 130 extracts a part that matches with the complex term that constitutes the term registered in the dictionary system 1 from the accepted searching document (Step S502). In the example of FIG. 27, the control unit 130 extracts complex terms “ [symbol] [symbol] (non-insulin (using “SHU” character) dependent diabetes in Japanese)” and “ [symbol] (type 2 diabetes in Japanese)”, which are registered terms.

Then, the control unit 130 extracts a part that matches with a simple term from the remaining part (Step S503). In the example of FIG. 27, the control unit 130 extracts a simple term “ [symbol] (insulin (using “SHU” character) in Japanese)” and a simple term “ [symbol] (diabetes in Japanese)”.

Then, the control unit 130 normalizes and stores the registered term that constitutes a document with a unit identifier containing the matched complex term and a unit identifier that contains a simple term (Step S504). In the example of FIG. 27, the registered term “ [symbol] (insulin (using “SHU” character) in Japanese)” will be replaced with a unit identifier “31DB02”, the registered term “ [symbol] [symbol] (non-insulin (using “SHU” character) dependent diabetes in Japanese)” is replaced with a sequence of unit identifiers “31DB02+1A2B3C+0F87AE”, the registered term “ [symbol] (type 2 diabetes in Japanese)” is replaced with a unit identifier “59C46B”, and the registered term “ [symbol] (diabetes in Japanese)” is replaced with a unit identifier “0F87AE”, so as to be normalized.

FIG. 29 is a flow chart showing reconfiguration processing of a dictionary in the dictionary system according to an example of the preferred embodiment of the present invention.

First, the control unit 130 determines whether or not the simple term that constitutes the simple term dictionary unit stored in the storage 150 contains a simple term that constitutes other simple term dictionary unit or a simple term that constitutes a complex term constituting a complex term dictionary unit (Step S601). If it is determined as such, the control unit 130 stores as a complex term containing the contained simple term (Step S602).

More specifically, for example, as shown in FIG. 30, if the storage 150 stores registered terms “ [symbol] (peripheral nerve in Japanese)” and “ [symbol] (peripheral nervous system in Japanese)” that are referred to using a unit identifier “A0011”, registered terms “ [symbol] (nervous disorder in Japanese)” and “ [symbol] (nervous disease in Japanese)” that are referred to using a unit identifier “B0022”, and a registered term “ [symbol] (nervous in Japanese)” referred to using a unit identifier “D01”, since registered terms “ [symbol] (peripheral nerve in Japanese)”, “ [symbol] (peripheral nervous system in Japanese)”, “ [symbol] (nervous disorder in Japanese)”, and “ [symbol] (nervous disease in Japanese)” contain the registered term “ [symbol] (nervous in Japanese)”, the control unit 130 stores these registered terms that are referred to using a unit identifier “A0011” and a unit identifier “B0022” as a “complex term.”

Furthermore, the control unit 130 may register a term divided by “ [symbol] (nervous in Japanese)”, that is, “ [symbol] (peripheral in Japanese)”, “ [symbol] (system in Japanese)”, “ [symbol] (disorder in Japanese)”, and “ [symbol] (disease in Japanese)” may be registered as simple terms. As a result, we obtain registration as shown in FIG. 33.

Therefore, if “ [symbol] (peripheral nervous disorder in Japanese)” is a search term or a term to be searched, “E02+D01+G04” is obtained by coding with a pointer of a simple term first, and we can see that there are “E02+D01” and “D01+G04” of complex terms that are registered in the dictionary inside the code. Thus, it is possible to make “ [symbol] (peripheral nervous disorder in Japanese)” into the following two kinds of search terms or index terms by replacing with pointers of the complex terms:

### E02+D01+G04→“A0011+G04”, “E02+B0022”

By expanding the registered terms from these pointers, it is possible to obtain the following search terms or index terms:

“ [symbol] (peripheral nervous disorder in Japanese)”, “ [symbol] [symbol] (peripheral nervous system disorder in Japanese)”, and “ [symbol] (peripheral nervous disease in Japanese)”

FIG. 34 is a flow chart showing partial match search processing in the dictionary system according to an example of the preferred embodiment of the present invention.

First, the control unit 130 accepts an input of a search request term (Step S701).

Then, the control unit 130 determines whether or not terms contained in a dictionary unit constituting a complex term or simple term contained in the search request term are contained in a searching document (Step S702).

If it is determined as such, the control unit 130 considers they are matched (Step S703).

Specifically, if the storage 150 is storing registered terms as shown in FIG. 35, a search term “ [symbol] [symbol] (lung inflammation characteristic of cytomegalovirus nature in Japanese)” becomes X0011+Y0022. Therefore, it is possible to search each of the term group registered in X0011 and the term group registered in Y0022. Thus, X0011 and Y0022 can be obtained from “ [symbol] [symbol] (acute lung organ inflammation by CMV in Japanese)”.

Furthermore, in a case where “ [symbol] [symbol] [symbol] (acute cytomegalovirus lung inflammation in Japanese)” is searched, even if there is no term to be searched that matches with the whole phrase, it is possible to search “ [symbol] (CMV lung organ inflammation in Japanese)” as a string that matches with a part of the phrase.

While the present invention has been described with reference to embodiments thereof, it should be appreciated that the present invention is not limited to the embodiments described above. Moreover, effects described for the embodiments of the present invention merely describe most preferable effects arise from the present invention, and effects of the present invention is not intended to be limited to the effects described for the embodiments of the present invention.

1. A dictionary system for searching a document or for normalizing a term constituting a document, the system comprising:
a storage for storing a simple term dictionary unit containing at least one simple term and a complex term dictionary unit that represents a complex term containing one of the simple terms constituting the simple term dictionary unit,
wherein each simple term that constitutes the complex term is referred to through a pointer (unit identifier) to the simple term dictionary unit.

2. The dictionary system according to claim 1, comprising:
a means for accepting an input of a search request term;
a means for extracting a part that matches with the complex term from the search request term accepted;
a means for extracting a part that matches with the simple term from the rest of the search request term thus accepted; and
a means for generating a search candidate term by combining all of the simple terms that are contained in the simple term dictionary unit that contains the simple term which constitutes the matched complex term and the matched simple term.

3. The dictionary system according to claim 1, further comprising:
a means for accepting an input of data that indicates a new association of a simple term or a complex term; and
a means for integrating, if the simple term(s) or the complex term(s) to which the new association is indicated constitutes a separate dictionary unit from each other, the separate dictionary units.

4. The dictionary system according to claim 1, further comprising:
a means for accepting an input of data that indicates a new association between complex terms; and
a means for generating, if a part of the complex term to which a new association is indicated constitutes the same dictionary unit, considering that the simple term(s) or the complex term(s) that constitutes the rest of the complex term are associated with each other, a new dictionary unit containing the simple term(s) or the complex term(s) that constitutes the rest of the complex term.

5. The dictionary system according to claim 1, further comprising:
a means for accepting an input of data that indicates division of a dictionary unit containing a plurality of simple terms or complex terms; and
a means for dividing the dictionary unit based on the accepted data that indicates division.

6. The dictionary system according to claim 1, further comprising
a means for storing, if the simple term that constitutes the simple term dictionary unit stored in the storage contains a simple term that constitutes other simple term dictionary unit or the simple term that constitutes a complex term that contains the contained simple term, a complex term containing the contained simple term.

7. The dictionary system according to claim 2, in which the system considers a search to be matched if a term contained in a dictionary unit that the complex term or the simple term contained in the search request term constitutes is contained in the searching document.

8. A program that causes a dictionary system to perform a search of a document or normalization of a term constituting a document,
in which the dictionary system comprises a storage for storing a simple term dictionary unit containing at least one simple term and a complex term dictionary unit that represents a complex term containing one of the simple terms constituting the simple term dictionary unit, and
in which the program causes the dictionary system to perform a step of referring to each simple term that constitutes the complex term through a pointer (unit identifier) to the simple term dictionary unit.

9. A document management apparatus including the dictionary system according to claim 1.
